(19) United States
(12) Patent Application Publication
(10) Pub. No.: US 2024/0191663 A1
(43) Pub. Date: Jun. 13, 2024

(54) PREDICTION EMISSION MONITORING

(71) Applicant: Baker Hughes Holdings LLC, Houston, TX (US)

(72) Inventors: Atanu Talukdar, Bangalore (IN); Steven Hadley, Sunol, CA (US); Somesh Chatterjee, Thane (IN); Sahill Ratnakumar Gandhi, Dubai (AE); Indu Kaladhar Polepeddy, Hyderabad (IN); Jagan Mohan Dannana, Dubai (AE); Gernot Ebner, Bruck an der Mur (AT)

(21) Appl. No.: 18/080,448

(22) Filed: Dec. 13, 2022

(51) Int. Cl. F02C 9/48; G05B 13/02; G05B 13/04

(52) U.S. Cl. CPC F02C 9/48; G05B 13/0265; G05B 13/048; F05D 2270/083; F05D 2270/3013; F05D 2270/303; F05D 2270/306; F05D 2270/311; F05D 2270/313; F05D 2270/44

(57) ABSTRACT

Sensor values indicative of operating parameters of a combustion system are received. An emission is determined, by at least a predictive model, based on at least the sensor values. The predictive model has been trained using at least a first set of data acquired from a measured emission and a second set of data determined using at least a physics model. Combustion system operating parameters are adjusted based on at least the determined emission.

### TECHNICAL FIELD

This disclosure relates to technologies for monitoring emissions.

### BACKGROUND

Industrial engines are used for power generation in a variety of facilities, such as power plants, oil and gas refineries, and factories. Such industrial engines are often the subject of emission regulations, meaning that the exhaust gasses emitted from these engines need be monitored and tracked. In some instances, emissions caps are imposed by regulatory agencies. In such instances, the operators of industrial engines take steps to ensure and prove that their industrial engines are producing emissions well under the imposed emissions caps. Common emissions that are regulated include carbon monoxide (CO), carbon dioxide (CO₂), unburned hydrocarbons, various nitrous oxides (NOₓ), and various sulphur oxides (SOₓ).

### SUMMARY

This disclosure relates to prediction emission monitoring.

An example implementation of the subject matter described within this disclosure is a method with the following features. Sensor values indicative of operating parameters of a combustion system are received. An emission is determined, by at least a predictive model, based on at least the sensor values. The predictive model has been trained using at least a first set of data acquired from a measured emission and a second set of data determined using at least a physics model. Combustion system operating parameters are adjusted based on at least the determined emission.

Aspects of the example method, which can be combined with the example method alone or in combination with other aspects, include the following. The emission includes any of the following: carbon monoxide (CO), carbon dioxide (CO₂), unburned hydrocarbons, nitrous oxide (NOₓ), or sulphur oxides (SOₓ).

Aspects of the example method, which can be combined with the example method alone or in combination with other aspects, include the following. The combustion system is a gas turbine engine. The sensor values include values indicative of the following: a compressor exit temperature, a compressor exit pressure, a fuel mass-flow rate, an ambient temperature, an ambient relative humidity, a power turbine inlet temperature, and an average power turbine exhaust temperature.

Aspects of the example method, which can be combined with the example method alone or in combination with other aspects, include the following. The predictive model is forward queried. Forward querying includes predicting emission outputs based on at least inputting, to the predictive model, values indicative of corresponding sensor values.

Aspects of the example method, which can be combined with the example method alone or in combination with other aspects, include the following. The predictive model is reverse queried. Reverse querying includes receiving a target emission value, determining a range of values indicative of operating parameters of the combustion system that result in the target emission, and controlling the combustion system based upon the target emissions.

Aspects of the example method, which can be combined with the example method alone or in combination with other aspects, include the following. The predictive model is retrained based on at least updated sensor values.

Aspects of the example method, which can be combined with the example method alone or in combination with other aspects, include the following. Retraining the predictive model includes the following steps. The combustion system is run in a first operating mode and a second operating mode. Data is received from multiple sensors during the first operating mode. Data is received from the multiple sensors during the second operating mode. The multiple sensors include an emissions sensor. The predictive model is retrained based on at least the received data.

Aspects of the example method, which can be combined with the example method alone or in combination with other aspects, include the following. Receiving data from the multiple sensors within the second operating mode includes receiving nine data points.

Aspects of the example method, which can be combined with the example method alone or in combination with other aspects, include the following. The emission is a first emission. The method further includes the following features. A second emission is determined by at least the retrained predictive model based on at least the sensor values. Combustion system operating parameters based on at least the second emission.

An example implementation of the subject matter described within this disclosure is a system with the following features. Memory stores instructions, which, when executed by at least one data processor causes the at least one data processor to perform the following operations. Sensor values indicative of operating parameters of a combustion system are received. An emission is determined by at least a predictive model based on at least the sensor values. The predictive model has been trained using at least a first set of data acquired from a measured emission and a second set of data determined using at least a physics model. Combustion system operating parameters are adjusted based on at least the determined emission.

Aspects of the example system, which can be combined with the example system alone or in combination with other aspects, include the following. The system further includes a combustion system, which includes a gas-turbine engine. The sensor values include values indicative of the following: a compressor exit temperature, a compressor exit pressure, a fuel mass-flow rate, an ambient temperature, an ambient relative humidity, a power turbine inlet temperature, and an average power turbine exhaust temperature.

Aspects of the example system, which can be combined with the example system alone or in combination with other aspects, include the following. The predictive model is configured to be recalibrated periodically based on at least updated sensor values.

Aspects of the example system, which can be combined with the example system alone or in combination with other aspects, include the following. Recalibrating the predictive model includes the following. The combustion system is run in a first operating mode and a second operating mode. The sensor values are received during the first operating mode. The sensor values are received during the second operating mode. The sensors include an emissions sensor. The predictive model is retrained based on at least the received sensor values.

Aspects of the example system, which can be combined with the example system alone or in combination with other aspects, include the following. Receiving sensor values within the first operating mode includes receiving nine data points.

Aspects of the example system, which can be combined with the example system alone or in combination with other aspects, include the following. The operations further include the following. The emission is determined by at least the retrained predictive model based on at least the sensor values. Combustion system operating parameters are adjusted based on at least the determined emission.

An example implementation of the subject matter described within this disclosure is a non-transitory computer readable memory storing instructions which, when executed by at least one data processor forming part of at least one computing system, causes the at least one data processor to perform the following operations. Sensor values indicative of operating parameters of a combustion system engine are received. An emission is determined by at least a predictive model based on at least the sensor values. The predictive model has been trained using at least a first set of data acquired from a measured emission and a second set of data determined using at least a physics model. Combustion system operating parameters are adjusted based on at least the determined emission.

Aspects of the example non-transitory computer readable memory, which can be combined with the example non-transitory computer readable memory alone or in combination with other aspects, include the following. The combustion system includes a gas-turbine engine. The data from sensors includes sensor values indicative of the following: a compressor exit temperature, a compressor exit pressure, a fuel mass-flow rate, an ambient temperature, an ambient relative humidity, a power turbine inlet temperature, and an average power turbine exhaust temperature.

Aspects of the example non-transitory computer readable memory, which can be combined with the example non-transitory computer readable memory alone or in combination with other aspects, include the following. The predictive model is configured to be recalibrated periodically based on at least updated sensor values.

Aspects of the example non-transitory computer readable memory, which can be combined with the example non-transitory computer readable memory alone or in combination with other aspects, include the following. Recalibrating the predictive model includes the following. The combustion system is run in a first operating mode and a second operating mode. Data is received from sensors during the first operating mode. Data is received from the sensors during the second operating mode. The sensors include an emissions sensor. The predictive model is retrained based on at least the received data.

Aspects of the example non-transitory computer readable memory, which can be combined with the example non-transitory computer readable memory alone or in combination with other aspects, include the following. The emission is a first emission. The non-transitory computer readable memory further includes instructions to perform the following. a second emission is determined by at least the retrained predictive model based on at least the received data from the sensors. Combustion system operating parameters are adjusted based on at least the determined second emission.

### BRIEF DESCRIPTION OF THE DRAWINGS

The accompanying drawings, which are incorporated in and constitute a part of this disclosure, show certain aspects of the subject matter disclosed herein and, together with the description, help explain some of the principles associated with the disclosed implementations.

FIG. 1 is a schematic diagram of an example gas-turbine system.

FIG. 2 is a flow diagram of an example machine learning model being trained and used.

FIG. 3 is a chart illustrating example forward queries.

FIG. 4 is a chart illustrating example reverse queries. FIG. 5 is a block diagram of an example controller that can be used with aspects of this disclosure.

FIG. 6 is a flowchart of an example method that can be used with aspects of this disclosure.

### DETAILED DESCRIPTION

Continuous, direct measurement of emissions from an industrial engine over an extended period is difficult due to temperatures, contamination, and sensor reliability. However, such monitoring, or alternative emissions tracking is required by some regulatory agencies. Every industrial engine is unique in its power and emission profile due to manufacturing tolerances, so generic emission models are often insufficient, especially as engine parameters change over time due to wear.

Some implementations of the subject matter relate to predicting emissions from an industrial machine using a predictive model, for example, a machine learning model, trained both on actual sensor data as well as a physics-based model. In some implementations, sensor values indicative of operating parameters of an industrial engine are received. Emissions are then determined by a machine learning model based on the sensor values. The machine learning model can have been trained using both empirical emissions data from sensors configured to sense parameters of an engine and calculated emissions data of an engine from a physics model. Once the emission values are determined, engine operating parameters can be adjusted to ensure the industrial engine is operating such that emissions are below a set threshold, such as a regulatory threshold. While the predictive model is primarily described in the context of a machine learning model, other predictive models can be used without departing from this disclosure. Combining the physics based modeling with the operational data from empirical emissions to train the machine learning model reduces the amount of time, power, and computing cycles to train the model for predicting emission levels.

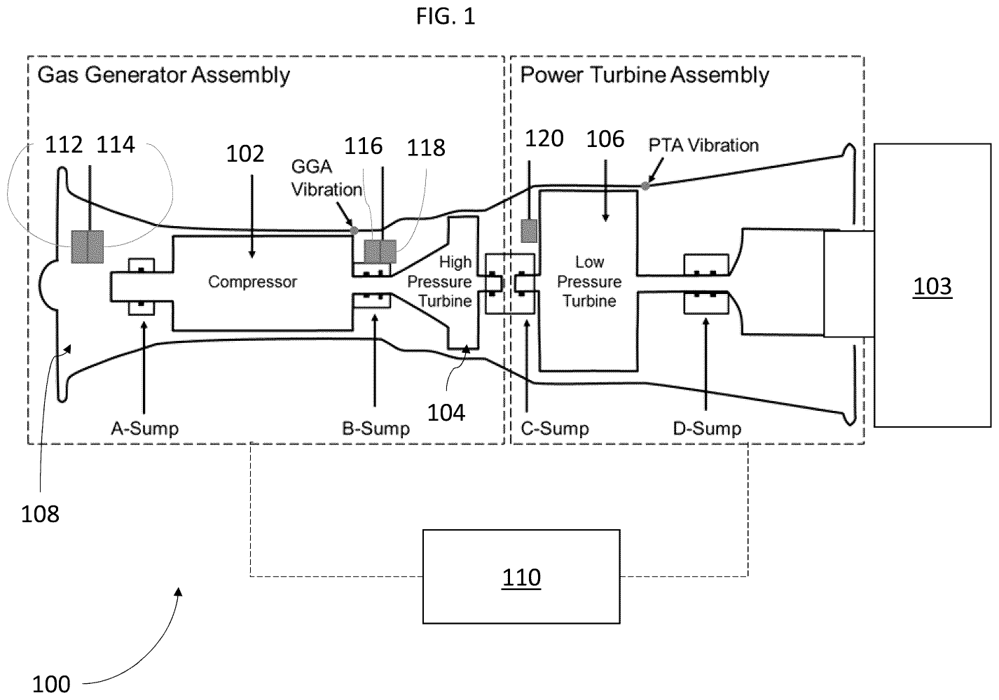

FIG. 1 is a schematic diagram of an example gas-turbine system 100. The gas-turbine 100 draws air into a compressor section 102 towards combustors. Fuel is added at a specified rate to the combustors and ignited. The expansion created by the heat of fuel ignition is used to drive a high-pressure turbine 104 and a low-pressure turbine 106. The high-pressure-turbine 104 drives the compressor 102 while the low-pressure turbine 106 drives and end user, such as a generator or other piece of rotating equipment 103.

The gas-turbine system 100 includes a variety of sensors that produce signals that include sensor values indicative of performance of a gas-turbine system 100. For example, the P2 sensor 112 and the T2 sensor 114 detect pressure and temperature, respectively, at an inlet 108 of a compressor 102. The P3 116 sensor measures a pressure of the compressor outlet prior to the combustors, and the T3 118 sensor measures a temperature at the same location. The T48 sensor 120 measures a temperature at an inlet of the low-pressure turbine 106. Additional sensor can be used to further measure parameters of the gas-turbine's operation.

The sensor are all coupled to a controller 110 used to monitor and control the gas-turbine system 100. For example, the various sensors produce signals indicative of the parameters the sensors are monitoring. These signals are received and processed by the controller 110. More details on the controller 110 are described throughout this disclosure.

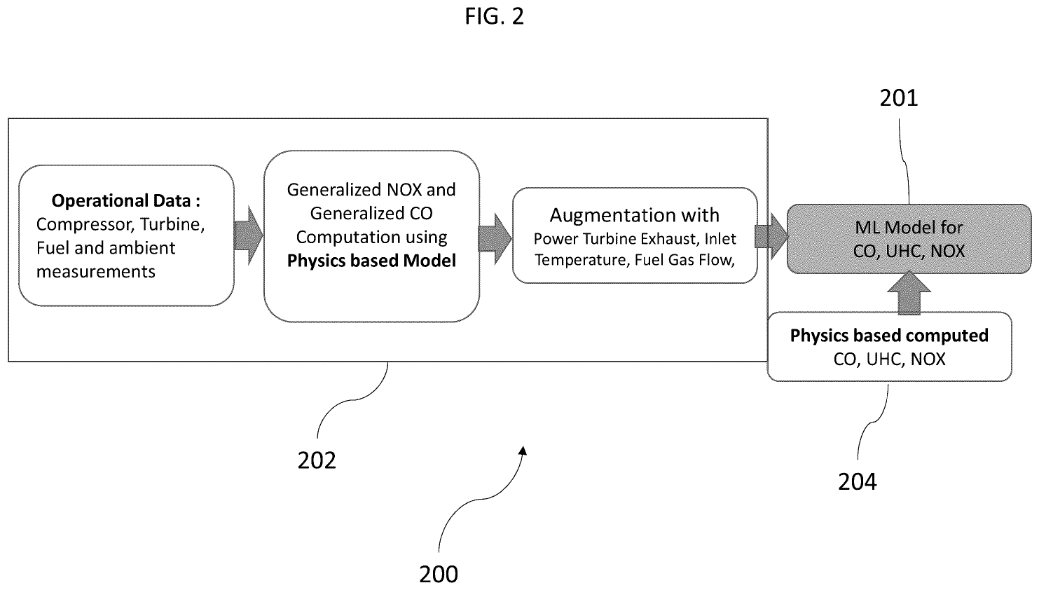

FIG. 2 is a process flow diagram 200 of an example machine learning model being trained and used with a gas-turbine, such as the example gas-turbine system 100 previously described. While primarily described in the context of a gas-turbine engine, the subject matter within this disclosure is similarly applicable to any combustion system, for example, a diesel reciprocating engine a furnace, or a boiler.

In training, the machine learning model 201 takes in various operating parameters, for example, pressures, flows, and ambient conditions of a combustions system. In some implementations, at 202, the machine learning model takes in operational data including data from the T2 sensor 114 (FIG. 1), the P2 sensor 112, the T48 sensor 120, a fuel flow rate, and a relative humidity and temperature. Similarly, at 204, the machine learning model takes data from a physics-based engine model, for example, NOₓ, CO, CO₂, SOₓ, and/or unburned hydrocarbon emissions. Combining the physics based modeling with the operational data to train the machine learning model reduces the amount of time, power, and computing cycles to train the model such that it performs the desired task, for example, predicting emission levels. Once the model is fully trained, the model can be used for a variety of tasks as describe herein

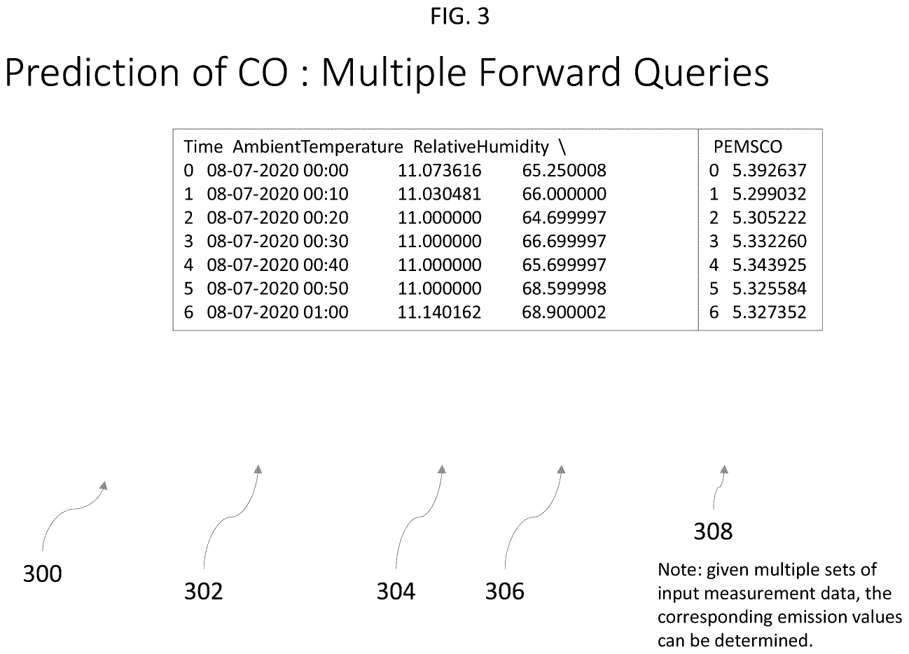

FIG. 3 is a chart 300 illustrating example forward queries. In the context of this disclosure, forward querying is used to predict emissions outputs based on inputting values indicative of corresponding sensor values. That is, a user is able to put details into the machine learning model, such as ambient temperature, humidity, and expected engine load, to predict a range of emissions that will occur during such conditions. For example, in the illustrated implementation, at a specified time 302, a user can input a predicted ambient temperature 304 and relative humidity 306. A predicted emission level 308 can then be determined and displayed based, at least in part, on the input ambient temperature 304 and relative humidity 306.

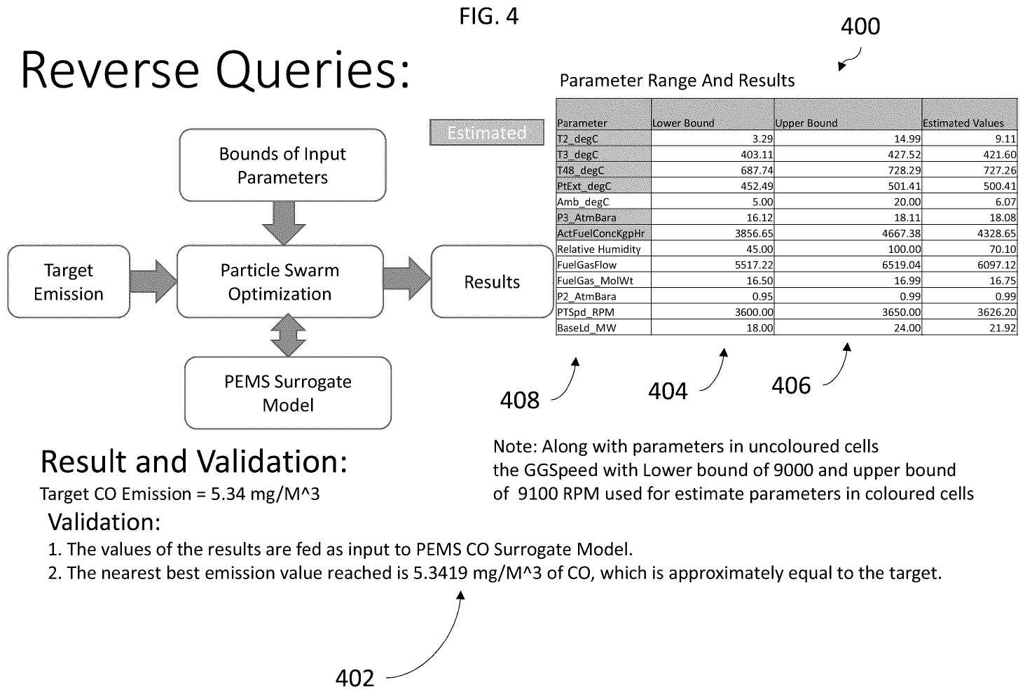

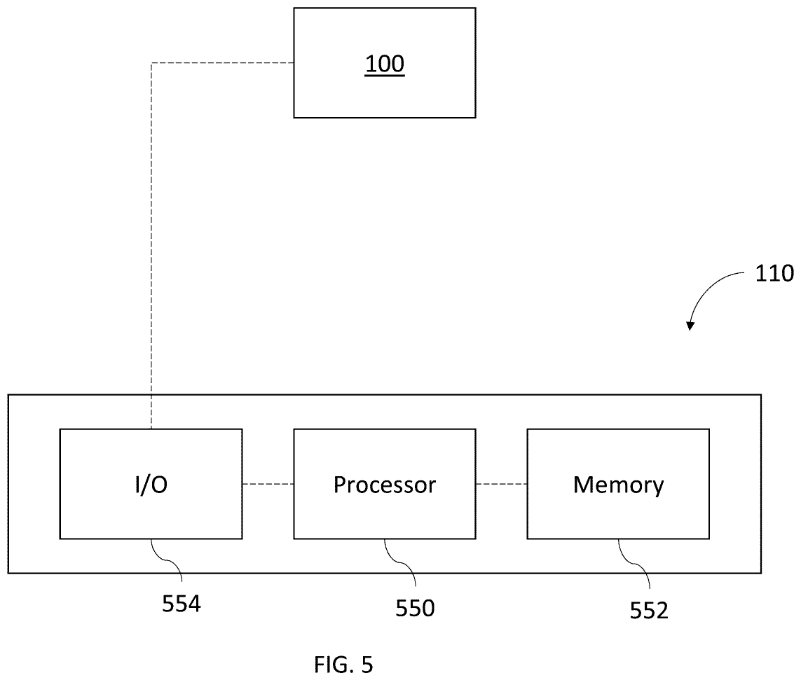

FIG. 4 includes a chart 400 illustrating example reverse queries. Reverse querying can be used to determine a range of values indicative of corresponding sensor values based on a target emission threshold. With a reverse query, a user is able to input a target emission threshold 402 into the machine learning model to predict a range, with an upper bound 404 and a lower bound 406, of ambient conditions and machine parameters 408 that will produce emissions at or below the target emission threshold 402. In some implementations, ranges of such parameters can be input to further narrow operating ranges, for example, the high and low temperatures from a weather forecast can be input for ambient temperature and pressure. In the illustrated implementations, the shaded parameters 408 are predicted based on the input ranges of the unshaded parameters 408.

FIG. 5 illustrates an example controller 110 that can be used with some aspects of the current subject matter. The controller 110 can, among other things, monitor parameters of the system 100 send signals to actuate and/or adjust various operating parameters of such systems. As shown in FIG. 5, the controller 110 can include one or more processors 550 and non-transitory computer readable memory storage (e.g., memory 552) containing instructions that cause the processors 550 to perform operations. The processors 550 are coupled to an input/output (I/O) interface 554 for sending and receiving communications with components in the system, including, for example, the T2 sensor 114, the P2 sensor 112, the T48 sensor 120, and/or a fuel flow rate sensor. In certain instances, the controller 110 can additionally communicate status with and send actuation and/or control signals to one or more of the various system components (including, for example, a fuel flow pump) of the system 100, as well as other sensors (e.g., pressure sensors, temperature sensors, vibration sensors and other types of sensors) that provide signals to the system 100.

The controller 110 can be implemented with various levels of autonomy. In some implementations, the controller 110 alerts an operator that a parameter is out of disclosure, for example, emissions are above a target threshold, and the operator then adjusts engine parameter to move the emissions below the desired emissions threshold. In some implementations, the controller 110 alerts the operator that a parameter is out of disclosure, and provides recommendations to the operator to move the parameter within disclosure. The operator then selects an option and the controller adjusts operations accordingly. In some instances, the controller 110 determines that a parameter is out of disclosure, and changes or otherwise adjusts operations to move the parameter within disclosure with no input from the operator.

In operation, the controller is configured to receiving sensor values indicative of operating parameters of the combustion system, for example, the gas-turbine system 100. The controller can then determine, determine, at least in part with the predictive model, an emission based on at least the sensor values. The predictive model can have been trained using at least a first set of data acquired from a measured emission and a second set of data determined using at least a physics model. Engine operating parameters can then be adjusted based on at least the determined emission. In some implementations, the predictive model is stored within the non-transitory memory 552.

In some implementations, the engine is a gas-turbine engine. In such instances, sensor values can include values indicative of a compressor exit temperature, a compressor exit pressure, a fuel mass-flow rate, an ambient temperature, an ambient relative humidity, a power turbine inlet temperature, and/or an average power turbine exhaust temperature.

In some instances, the machine learning model is retrained, or recalibrated, based on updated empirical data. In such instances, the engine coupled to the controller is ran in various operating modes. Data is received from various sensors (including an emissions sensor) within various operating modes. The machine learning model stored within the non-transitory memory 552 is then retraining based on the received data, such as received sensor values. After the model is retrained, the controller determines (using the model) emissions based on the sensor values. More specifically, emission values are determined without the use of an emission sensor. The controller then adjusts operation parameters of the engine based on the determined emissions, for example, to maintain emissions below a regulatory threshold.

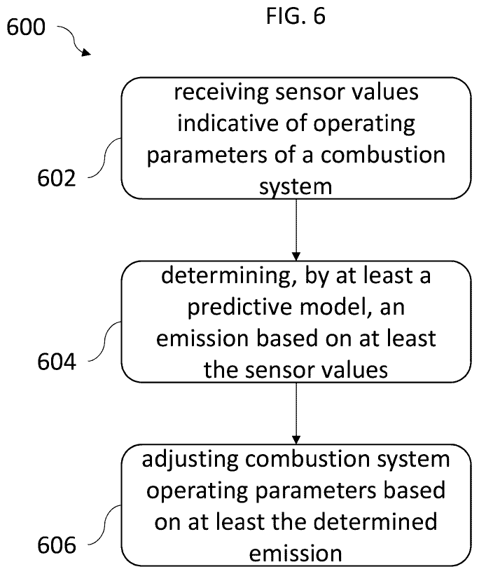

FIG. 6 is a flowchart of an example method 600 according to some example implementations. Aspects of the method 600 can be performed by the controller 110 all or in part. At 602, sensor values indicative of operating parameters of a combustion system, such the gas-turbine engine 100, are received. At 604, an emission is determined, by at least a predictive model, based on at least the sensor values. The predictive model can have been trained using at least a first set of data acquired from a measured emission and a second set of data determined using at least a physics model. In some implementations, the predictive model can include a machine learning model. At 606, combustion system operating parameters are adjusted based on at least the determined emission. .

Periodically, the machine learning model can be recalibrated based on updated empirical data. Such recalibration can be performed on a periodic basis per applicable regulations and standards. In such instances, the gas-turbine system 100 can be run in various operating modes. For example, start-up, shut-down, low load, medium load, and high load operating modes. In some implementations, only three operating modes are used. While operating in the various mode, data is received from various sensors. An emissions sensor is included during this phase. The model is retrained (or further trained) based on the received data from the recalibration runs. As the model has previously been trained on both empirical and physics model data, a low number of data points is needed in each mode, For example, less than ten data points. In some implementations, only nine data points are needed during each operating mode. That is, only nine data points in three operating modes are necessary to retrain the model. For example, if three operating modes are retrained, twenty-seven data points are taken for retraining. Once the model is retrained, emissions can be determined based solely on sensor values, for example, values indicative of a compressor exit temperature, a compressor exit pressure, a fuel mass-flow rate, an ambient temperature, an ambient relative humidity, a power turbine inlet temperature, and/or an average power turbine exhaust temperature. An emissions sensor or a value indicative of an emission level from an emission sensor is not needed. Engine operating parameters are then adjusted based on the determined emissions, for example, the operations are adjusted such that the emission levels are below a specified threshold.

While this disclosure contains many specific implementation details, these should not be construed as limitations on the scope of what may be claimed, but rather as descriptions of features specific to particular implementations of particular inventions. Certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the implementations described above should not be understood as requiring such separation in all implementations, and it should be understood that the described components and systems can generally be integrated together in a single product or packaged into multiple products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results.

Other implementations can be within the scope of the following claims.

What is claimed:

1. A method comprising:
receiving sensor values indicative of operating parameters of a combustion system;
determining, by at least a predictive model, an emission based on at least the sensor values, wherein the predictive model has been trained using at least a first set of data acquired from a measured emission, and a second set of data determined using at least a physics model; and
adjusting combustion system operating parameters based on at least the determined emission.

2. The method of claim 1, wherein the emission comprises:
carbon monoxide (CO);
carbon dioxide (CO₂);
unburned hydrocarbons;
nitrous oxide (NOₓ); or
sulphur oxides (SOₓ).

3. The method of claim 1, wherein the combustion system is a gas turbine engine, wherein the sensor values comprise values indicative of:
a compressor exit temperature;
a compressor exit pressure;
a fuel mass-flow rate;
an ambient temperature;
an ambient relative humidity;
a power turbine inlet temperature; and
an average power turbine exhaust temperature.

4. The method of claim 1, further comprising forward querying the predictive model, wherein forward querying comprises predicting emissions outputs based on at least inputting, to the predictive model, values indicative of corresponding sensor values.

5. The method of claim 1, further comprising reverse querying the predictive model, wherein reverse querying comprises:
receiving a target emission value;
determining a range of values indicative of operating parameters of the combustion system that result in the target emissions; and
controlling the combustion system based upon the target emissions.

6. The method of claim 1, further comprising:
retraining the predictive model based on at least updated sensor values.

7. The method of claim 6, wherein retraining the predictive model comprises:
running the combustion system in a first operating mode and a second operating mode;
receiving data from a plurality of sensors during the first operating mode;
receiving data from the plurality of sensors during the second operating mode, the plurality of sensors comprising an emissions sensor; and
retraining the predictive model based on at least the received data.

8. The method of claim 7, wherein receiving data from the plurality of sensors within the second operating mode comprises receiving nine data points.

9. The method of claim 7, wherein the emission is a first emission, the method further comprising:
determining, by at least the retrained predictive model, a second emission based on at least the sensor values; and
adjusting combustion system operating parameters based on at least the second emission.

10. A system comprising:
at least one data processor; and
memory storing instructions, which, when executed by the at least one data processor causes the at least one data processor to perform operations comprising:
receiving sensor values indicative of operating parameters of a combustion system;
determining, by at least a predictive model, an emission based on at least the sensor values, wherein the predictive model has been trained using at least a first set of data acquired from a measured emission, and a second set of data determined using at least a physics model; and
adjusting combustion system operating parameters based on at least the determined emission.

11. The system of claim 10, further comprising the combustion system, wherein the combustion system comprises a gas-turbine engine, wherein the sensor values comprise values indicative of:
a compressor exit temperature;
a compressor exit pressure;
a fuel mass-flow rate;
an ambient temperature;
an ambient relative humidity;
a power turbine inlet temperature; and
an average power turbine exhaust temperature.

12. The system of claim 11, wherein the predictive model is configured to be recalibrated periodically based on at least updated sensor values.

13. The system of claim 10, wherein recalibrating the predictive model comprises:
running the combustion system in a first operating mode and a second operating mode;
receiving the sensor values during the first operating mode:
receiving the sensor values during the second operating mode, the sensors comprising an emissions sensor; and
retraining the predictive model based on at least the received sensor values.

14. The system of claim 13, wherein receiving sensor values within the first operating mode comprises receiving nine data points.

15. The system of claim 14, the operations further comprising:
determining, by at least the retrained predictive model, the emission based on at least the sensor values; and
adjusting combustion system operating parameters based on at least the determined emission.

16. A non-transitory computer readable memory storing instructions which, when executed by at least one data processor forming part of at least one computing system, causes the at least one data processor to perform operations comprising:
receiving sensor values indicative of operating parameters of a combustion system engine;
determining, by at least a predictive model, an emission based on at least the sensor values, wherein the predictive model has been trained using at least a first set of data acquired from a measured emission, and a second set of data determined using at least a physics model; and
adjusting combustion system operating parameters based on at least the determined emission.

17. The non-transitory computer readable memory of claim 16, wherein the combustion system comprises a gas-turbine engine, wherein the data from sensors comprises sensor values indicative of:
a compressor exit temperature;
a compressor exit pressure;
a fuel mass-flow rate;
an ambient temperature;
an ambient relative humidity;
a power turbine inlet temperature; and
an average power turbine exhaust temperature.

18. The non-transitory computer readable memory of claim 16, wherein the predictive model is configured to be recalibrated periodically based on at least updated sensor values.

19. The non-transitory computer readable memory of claim 16, wherein recalibrating the predictive model comprises:
running the combustion system in a first operating mode and a second operating mode;
receiving data from a plurality of sensors during the first operating mode;
receiving data from the plurality of sensors during the second operating mode, the plurality of sensors comprising an emissions sensor; and
retraining the predictive model based on at least the received data.

20. The non-transitory computer readable memory of claim 19, wherein the emission is a first emission, the non-transitory computer readable memory further comprising instructions to:
determining, by at least the retrained predictive model, a second emission based on at least the received data from the plurality of sensors; and
adjusting combustion system operating parameters based on at least the determined second emission.
